(19) United States
(12) Patent Application Publication
(10) Pub. No.: US 2026/0287068 A1
(43) Pub. Date: Sep. 24, 2026

(54) Valve for Use in a Vehicle Cooling Circuit as Well as Method and Tool for Producing such a Valve

(71) Applicant: HANON SYSTEMS EFP DEUTSCHLAND GMBH, Bad Homburg v.d. Höhe (DE)

(72) Inventor: Tilo Schäfer, Daubach (DE)

(21) Appl. No.: 19/427,248

(22) Filed: Dec. 19, 2025

(30) Foreign Application Priority Data
Mar. 19, 2025 (DE) 102025110661.4

(51) Int. Cl. F16K 3/02; F16K 3/08

(52) U.S. Cl. CPC F16K 3/0236; F16K 3/08

(57) ABSTRACT

A valve for use in a vehicle, in particular in a cooling circuit, including a rotating valve element that is axially in sliding contact with at least one disk and, optionally, also radially in sliding contact with a cylinder, wherein the disk and, optionally, the cylinder include, in a sliding layer, 3 to 7 vol %, in particular approximately 5 vol %, of substantially spherical particles, in particular made of glass or ceramic. Further, a method for producing a valve including a rotating valve element that is axially in sliding contact with a disk and, optionally, also radially in sliding contact with a cylinder, wherein the disk and, optionally, the cylinder are provided, in a sliding layer, with 3 to 7 vol %, in particular approximately 5 vol %, of substantially spherical particles, in particular made of glass or ceramic.

### CROSS REFERENCE TO RELATED PATENT APPLICATIONS

The present application claims priority to German Patent Application No. DE 102025110661.4, filed Mar. 19, 2025, the entire contents of which are incorporated herein for all purposes by reference.

### TECHNICAL FIELD

The invention relates to a valve for use in a vehicle, in particular in a cooling circuit, as well as to a method and a tool for producing such a valve.

### BACKGROUND

The cited valves, such as are shown, for example, in DE 10 2022 214 438 A1, U.S. Pat. Nos. 9,638,340 B2, and 11,781,662 B2, US 2022381354 A1 or U.S. Pat. No. 11,428,338 B2, usually comprise a rotating valve element, also referred to as a puck, which rotates substantially about the central axis of the valve element in sliding contact with at least one disk and, optionally, a radially adjacent cylinder surface. In order to limit wear, in particular on the disk, and to limit (creep) deformation over the service life, the disks are usually ceramic. However, this makes them comparatively expensive to produce and the sintering process usually used has a high energy consumption. Furthermore, the friction values, in particular the static friction values, are in need of improvement, with the result that the currently used valves require comparatively powerful actuators.

### SUMMARY

Against this background, the invention is based on the object of improving such a valve, in particular with regard to the requirements imposed due to friction.

This object is firstly solved by the valve described herein.

According thereto, this valve comprises a disk that is in sliding contact with a rotating valve element, which valve element is optionally also radially in sliding contact with a cylinder. The invention can therefore also be applied to valves such as shown in U.S. Pat. No. 11,781,662 B2 or US 2022 381 354 A1, which are made subject matter of the present application as regards the details of such a valve design.

According to the invention, the disk comprises substantially spherical, hollow or solid particles, in particular made of glass or ceramic, in a sliding layer. This is advantageous inasmuch as the disk can be made, according to the invention, of a material which, in particular when exposed to heat, tends to soften at least to a certain extent and/or exhibits shrinkage. The disk tends to “cling” to the typically harder sliding partner, i.e. the valve element, which has a negative effect on the friction properties, both for the sliding friction and, in particular, for the static friction. Comparatively high forces are required to tear apart the idle components that are moveable relative to one another. This, on the one hand, requires comparatively powerful actuators and, on the other hand, reduces the service life thereof.

The disadvantages of a comparatively high static friction are significantly reduced by the particles according to the invention that are in the sliding layer. These particles advantageously prevent the described clinging, and thus the friction values, in particular the static friction values, can be significantly reduced, the use of comparatively powerful actuators can be avoided and the service life thereof can be extended.

As regards the proportion of the particles in volume percent, 3 to 7 volume percent is provided, and particularly favorable properties have been found for approximately 5 volume percent. The particles are typically evenly distributed in the material of the disk.

Embodiments of the invention are described herein.

The materials specified for the sliding layer are, on the one hand, expected to have good sliding and wear properties. On the other hand, the particles according to the invention can advantageously be well embedded in the specified materials. Due to the chain length of the polymers, they also have good mechanical properties and, by means of suitable flow improvers, can furthermore be produced in an advantageous and economic manner by injection moulding. The good mechanical and friction properties particularly apply in combination with a valve element which, in terms of dimensional accuracy, rigidity and/or hardness, is made of a comparatively hard material, such as PPS or PK. PE-UHMW, ultra-high molecular weight polyethylene, may in particular be used.

Favorable properties are furthermore expected for particles having a diameter of 20 to 50 μm, in particular approximately 30 to 40 μm. This is a statistical figure indicating that, for example, 90% of the spheres are in this diameter range. Such spheres are available on the market as aggregates for plastic mixtures and are incorporated during compounding of the granulate. The specified maximum size of the spheres has the advantage that the risk of the spheres breaking during extrusion or injection moulding as well as during subsequent operation due to the load of the preload between the disk and the valve element can be avoided. At the same time, particles with the specified minimum diameter are comparatively cost-effective as compared to even smaller particles.

The disk is furthermore preferably supported by a carrier that additionally comprises integrated sealing elements. The carrier ensures the required service life and, for this purpose, has good resistance to creep deformation. The disk can simultaneously be optimised in terms of friction and/or wear properties, such that an improved valve can overall be provided, which can at the same time be produced in an economic manner. The integrated sealing elements furthermore advantageously ensure tightness against the media regulated by the valve. As regards the carrier with integrated sealing elements as described above, it should be noted that this aspect is independent of the details of a valve described above and in the following. In other words, such a carrier is to be regarded as subject matter of the present disclosure which can be combined with any other features of a valve described herein.

Tightness is ensured in particular by the materials specified. The resistance of the carrier described above can be ensured by the materials specified for the carrier.

In order to create a secure connection between the carrier and the sealing elements, the carrier comprises at least one recess or groove into which a sealing element or, in particular, a projection thereon engages. Such a structure first of all ensures a secure connection between the two components. The engaging of projections and recesses furthermore creates a kind of labyrinth seal, such that tightness between the two components can be ensured. If the projections and recesses furthermore extend radially, as is preferred, problems can additionally be avoided that may otherwise occur as a result of the different thermal expansion of the two components. The at least one recess or groove on the carrier also has the advantage that contaminants can be collected and corresponding disturbances on the contact surface between the valve element and the disk can be prevented.

As explained above, the particles according to the invention display their advantages in particular in the case of a disk material that has a comparatively low melting temperature, such that there is a risk that it will become so soft during operation that it “clings” to the typically harder sliding partner and adheres thereto or interlocks therewith. Consequently, a melting temperature of 120 to a maximum of 170° C. is preferred for the disk material.

To ensure a secure connection between the carrier and the disk, the carrier and/or the disk comprises at least one, preferably radially extending, projection or a recess that engages with a recess or projection in the disk and/or the carrier.

As also explained above, comparatively high friction values, in particular static friction values, occur due to the fact that there is a certain surface pressure between the sliding partners, which is, however, necessary to ensure tightness. In this respect, a surface pressure between the valve element and disk of 0.05 to 0.1 MPa is currently preferred, with this value being selected depending on the differential pressure requirements of the connected ports of the valve.

To ensure secure anchoring in a valve housing, it is currently also preferred for the carrier to comprise at least one projection and/or at least one recess for anchoring in the housing in order to counteract any undesirable rotation of the carrier and consequently of the disk as a whole relative to the housing.

In accordance with the basic idea of the invention, the method according to the invention for producing a disk for a valve for use in a vehicle, in particular a cooling circuit, is characterised in that the disk (16) and, optionally, the cylinder are provided, in a sliding layer (34), with 3 to 7 vol %, in particular approximately 5 vol %, of substantially spherical particles (46), in particular made of glass or ceramic.

A rotating valve element is preferably provided on at least one surface axially in sliding contact with a disk and, optionally, also a surface radially in sliding contact with a cylinder with a roughness Rz of 4 to 10, in particular 6 to 8 micrometers, and/or with a structure comprising channels or grooves that preferably extend substantially transversely to the pressure gradient, with a depth of 8 to 15, in particular 10 to 13 micrometers. The roughness may be produced, for example, during forming of the valve element in a tool by processing the tool by means of laser, erosion, e.g. in accordance with VDI 3400, etching and/or blasting, for example with glass or steel balls. The roughness can therefore be realised in the tool using comparatively simple measures such that the valve element produced therein is reliably provided with the advantageous roughness described above. An etching process hereby has the advantage that the structures are comparatively blunt or round and in any case do not have sharp edges. Such structures, if produced with too sharp edges by laser or erosion, can advantageously be rounded off, for example by means of the described blasting. A structure produced using a laser has the advantage that the direction of recesses created in the cylinder end face can be selected such that these slots, grooves or channels can be formed in the valve sealing surface transversely to the direction of a pressure gradient and therefore cannot come into question as preferred channels for possible leaks in the closed state.

Within the scope of the method according to the invention, the preferably provided carrier can be produced in a particularly simple manner by moulding, in particular injection moulding, at least one sealing element thereon. In other words, in a first step, the carrier can be produced in an injection moulding tool and, before the second step, a slider can be moved into this tool, which frees up space for a second component, i.e. the sealing element, such that it is moulded onto the carrier in a second shot and forms a kind of hot-melt bond therewith. Alternatively, the carrier can be produced first and the sealing element moulded onto it can be produced in a second tool. In both cases, the carrier material and the base polymer of the seal are preferably selected such that they are related or even chemically identical, e.g. a carrier made of polypropylene and a seal made of a TPV, which can basically be described in simplified terms as a mixture of polypropylene and rubber (e.g. EPDM).

The invention furthermore provides a tool for producing a valve element which, on at least one surface forming a sliding contact surface of a valve element, has a roughness Rz of 4 to 10, in particular 6 to 8 μm, and/or a structure preferably produced by a laser that comprises channels or grooves having a depth of 8 to 15, in particular 10 to 13 micrometers. The improved valve element according to the invention can be created in an advantageous manner by means hereof.

Furthermore, the procedural approach for producing the various embodiments of the valve corresponds to the one described above with respect to the valve, and, in general, any features described above and below only with regard to the valve or the tool can also be applied to the production method and vice versa.

### BRIEF DESCRIPTION OF THE DRAWINGS

Preferred embodiments of the invention will be explained in more detail below with reference to the drawings. The figures show the following:

FIG. 1 a sectional view of essential parts of the valve according to the invention;

FIG. 2 a sectional view of essential parts of a further valve according to the invention;

FIG. 3A a perspective bottom view of the valve element;

FIG. 3B a sectional view of the valve element shown in FIG. 3A;

FIG. 3C a detail of FIG. 3B;

FIG. 4 a perspective view of the disk;

FIG. 5 a top view of the disk;

FIG. 6 a sectional view of the disk;

FIG. 7 a detail of FIG. 6;

FIG. 8 a perspective view of a carrier;

FIG. 9 a top view of the carrier;

FIG. 10 a sectional view of the carrier;

FIG. 11 a bottom view of the carrier;

FIG. 12 a perspective bottom view of the carrier;

FIG. 13 a detail of FIG. 10;

FIG. 14 a perspective view of a further disk;

FIG. 15 a first perspective view of a radial sliding partner;

FIG. 16 a second perspective view of a radial sliding partner;

FIG. 17 a perspective view of a further valve element, and

FIG. 18 test results regarding the proportion of spherical particles.

### DETAILED DESCRIPTION OF AN EMBODIMENT OF THE INVENTION

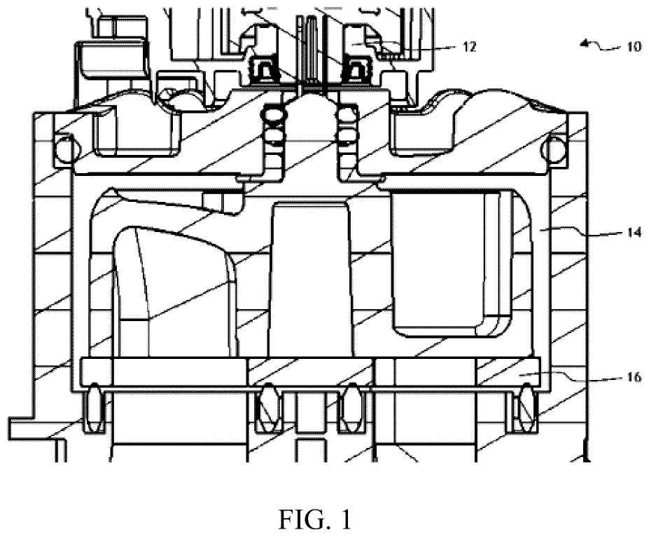

As is apparent in FIG. 1, a valve 10 according to the invention substantially comprises a rotary actuator 12 and a rotating valve element 14 in the form of a so-called puck, comprising suitable chambers and openings. In the shown case, the valve element 14 is in sliding contact with a disk 16, which is shown in more detail in the further figures. The valve element 14 comprises suitable chambers and deflections in order to ensure the desired fluid flows depending on the rotational position. Such a valve is apparent, for example, from DE 10 2022 214 438 A1, which is made subject matter of the present application as regards the details of such a valve design.

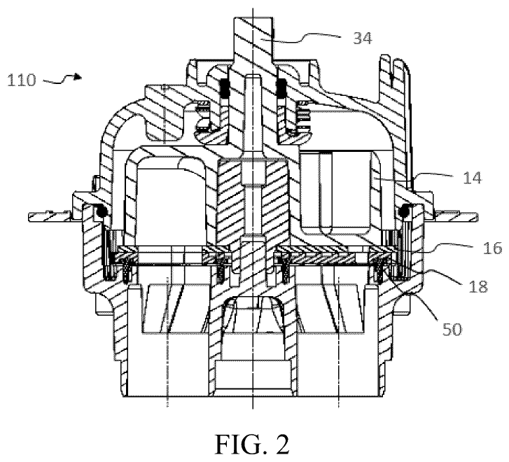

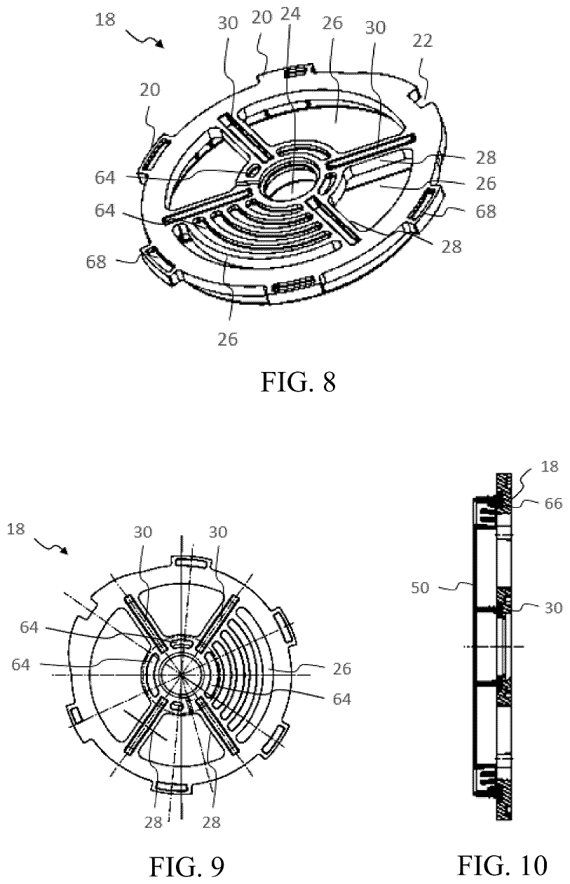

The further embodiment of a valve 110 shown in FIG. 2 has a similar configuration. However, no actuator is shown in FIG. 2, rather only the valve element 14 described in more detail below and its axle 34. In this case too, the valve element interacts with a disk 16, which in this case, however, is provided on a carrier 18. Details in this regard are apparent from FIGS. 8 to 13 and the corresponding description. It can be seen in FIG. 2 how the seals 50, described in more detail below, are inserted into corresponding grooves in the housing of the valve 110.

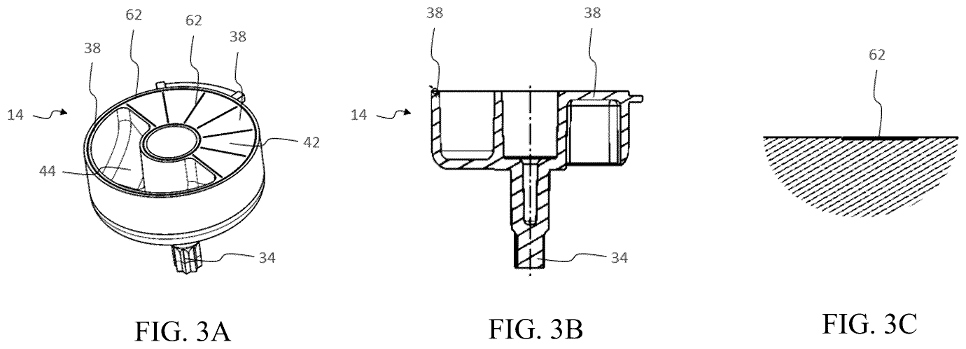

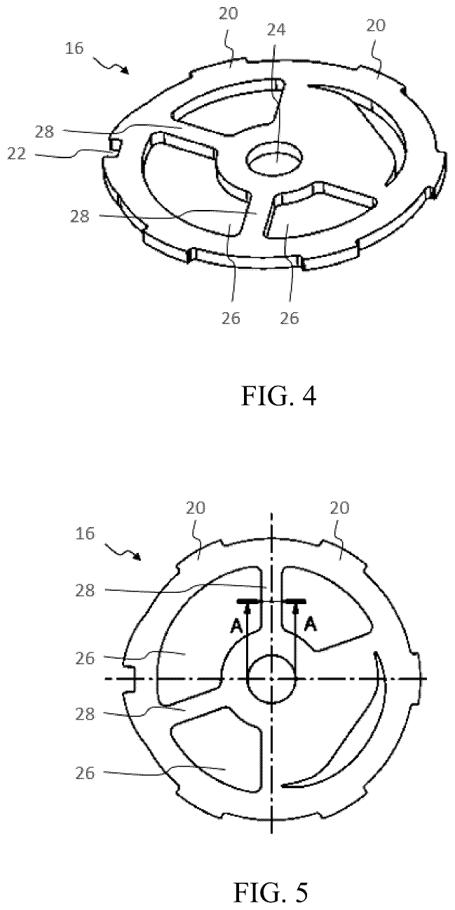

The valve element 14 shown in FIG. 3 thus interacts, as mentioned in sliding contact, with the disk 16 shown as an example in FIG. 4. Alternatively, as mentioned, a carrier 18 such as shown in FIG. 8, which can also be referred to as a carrier plate, may be used with a sliding disk such as shown in FIG. 14.

As can be seen in FIG. 3, the valve element 14 first of all comprises an axle 34 that is connected to an actuator for rotatably driving the valve element 14 about the axle 34. In the shown case, the valve element 14 furthermore consists of two concentric cylinders. Openings and chambers are formed between the two cylinders in order to control the desired fluid flow through the valve element 14. The axial sliding surfaces of the valve element 14 are labelled 38. On at least one of these sliding surfaces 38, the valve element 14 either has the advantageous roughness described above, or grooves 62 are formed which have a depth of 8 to 15 μm and preferably a width of 0.2 to 0.5 mm, in particular approximately 0.3 mm. As can be seen in FIG. 3A, they are furthermore preferably aligned transversely to the prevailing pressure gradient. In other words, the groove in the circular ring-shaped sealing surfaces 38 that are formed on the aforementioned concentric cylinders is circular, and in the region of the substantially semicircular sliding surface 38, which can be seen at the top right of FIG. 3A, it is radial. In the shown case, seven grooves 62 are formed in the described semicircle.

In FIG. 3A, an opening 44 extending over approximately 180° can also be seen on the underside 42 of the valve element 14 in the lower left-hand region of the figure.

FIG. 3B shows a sectional view of the valve element 14, as can also be seen in FIGS. 1 and 2, and the detail in FIG. 3C shows a groove 62 formed thereon.

The disk 16 shown in FIG. 4 comprises, in the shown case, projections 20 distributed around the circumference and, in the shown case, a single recess 22, which serve anchoring in the housing shown in FIG. 1. Furthermore, the disk 16 in the shown case is, with the exception of the described projections 20 and a widening of the outer circumference on both sides in the vicinity of the recess 22, substantially circular disk-shaped and comprises, in the shown case, a central opening 24 corresponding to approximately one quarter to one fifth of the diameter and four sector-shaped openings 26 distributed evenly over the circumference. Webs 28 are formed between each of the openings 26, and the opening on the right in FIG. 4 is radially much smaller than the other three openings 26. This opening is furthermore configured as a slot that is radially comparatively far out and extends approximately 1.5 times further along the circumference compared to the other two openings, as does the opening shown on the left in FIG. 4.

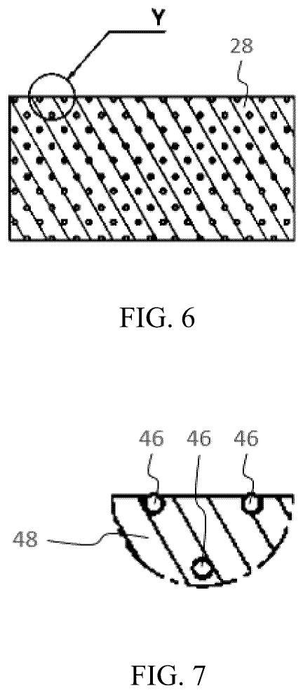

FIG. 5 shows a top view of the disk 16 and the location of the section A-A shown in FIG. 6. The section in FIG. 6 shows a web 28, but it is important to stress that the measures described below are essentially homogeneous for the entire disk 16.

As can be seen in FIG. 6, substantially spherical particles 46 are distributed substantially homogeneously throughout the material of the disk.

As can be seen in particular in FIG. 7, some particles 46 are accordingly also located at the surface and, due to their higher hardness as compared to the material 48 of the disk, prevent the valve element 14 from adhering to the disk 16 as a result of the “clinging” described above. Sliding friction can advantageously also be reduced as a result hereof.

As can be seen in FIG. 8, a carrier 18, which may be provided in particular for supporting the disk 16 shown in FIG. 14, comprises, in the shown case, projections 20 distributed around the circumference and, in the shown case, a single recess 22, which serve anchoring in the housing shown in FIG. 1. Furthermore, the carrier 18 in the shown case is, with the exception of the described projections 20 and a widening of the outer circumference on both sides in the vicinity of the recess 22, substantially circular disk-shaped and comprises, in the shown case, a central opening 24 corresponding to approximately one quarter to one fifth of the diameter and four sector-shaped openings 26 distributed evenly over the circumference. Webs 28 are formed between each of the openings 26, which, in the shown example, serve to accommodate sealing elements 50 that are shown in more detail in FIGS. 9 to 12.

In terms of their size and distribution around the circumference, the openings 26 substantially correspond to those of the disk 16 shown in FIGS. 4 and 5. Accordingly, the opening 26 shown at the bottom of FIG. 8, which extends over more than a quarter circle in the circumferential direction, is formed radially at the outside and passes all the way through, i.e. is a slot extending through the material of the carrier 18. A plurality of recesses 64, four in the shown case, are formed radially inside thereof, which extend in the circumferential direction, do not pass all the way through, and act as a kind of dirt trap groove. The same applies to the recesses 64 in the region of the inner circular web.

The aforementioned webs 28 are approximately as wide as the circular web between the central opening 24 and the sector-shaped openings 26. In the shown case, the carrier 18 comprises recesses 68 in the region of the aforementioned projections 20, which reduce the accumulation of material occurring there, which is particularly apparent in FIG. 10, and thus prevent so-called sink marks during injection moulding.

As regards the shown openings 24 and 26, it goes without saying that these may also be configured differently in terms of number and shape. For example, the central opening 24 may be omitted and/or the sector-shaped openings 26 may extend further or less far in the circumferential direction and/or in the radial direction. Furthermore, one or more sector-shaped openings 26 may be closed or largely closed, which still enables the formation of the recesses 30 in the carrier 18.

As can be seen in FIGS. 8 and 9, the carrier on the one hand comprises, on the side facing the disk 16, recesses 30 in the radial webs 28 and, in the shown case, also in the central, circular ring-shaped web, which serve to accommodate the projections 32 of the sliding disk according to FIG. 14. As mentioned above, the recesses 64 serve to collect contaminants. This essentially prevents contaminants from remaining between the carrier 18 and the disk 16.

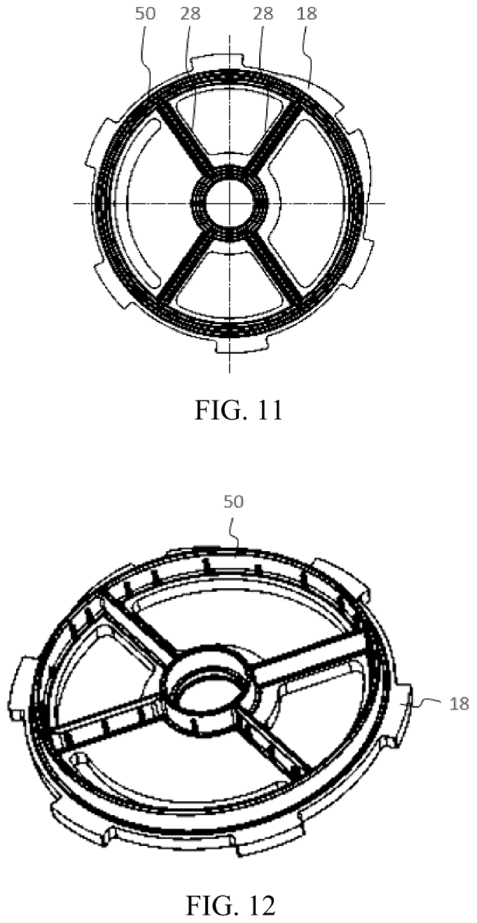

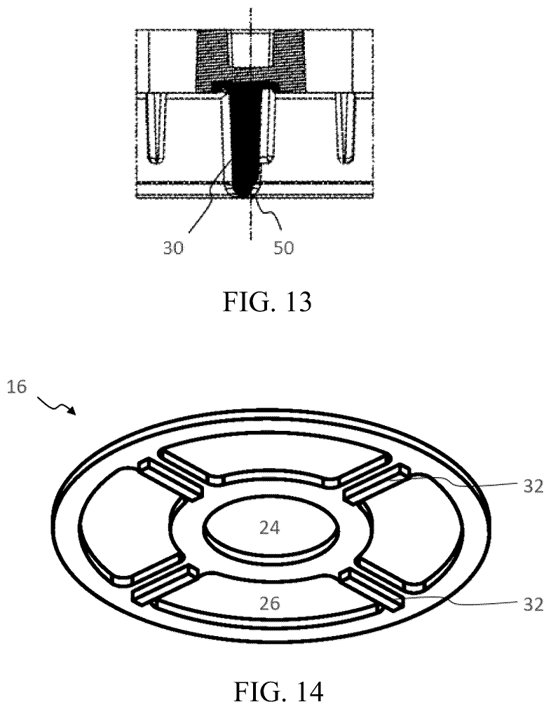

On the other hand, as can be seen in particular in FIG. 10, the carrier 18 also comprises recesses 66 on the opposite side, into which portions of a sealing element 50 are inserted. This is also shown in FIG. 13. It can be seen in FIG. 10 in combination with the bottom view of FIG. 11 that the carrier 18 comprises the recesses 66 for receiving the sealing element 50 substantially on the outer and the inner, substantially circular ring as well as the webs 28 therebetween. The sealing element 50 has the corresponding shape consisting of two concentric circular rings and, in the shown case, four webs extending therebetween, but with a smaller width than that of the webs of the carrier 18.

It is apparent from FIG. 10 and, additionally, the perspective bottom view of FIG. 12 that the sealing element 50 has a slightly greater axial extension, approximately 1.5 to 2 times that of the carrier 18. As mentioned, the sealing element 50 can be moulded, in particular injection moulded, onto the carrier 18 in an efficient manner, for example by first producing the carrier 18 and then injection moulding the sealing element 50 in one and the same tool. As can be seen in FIGS. 10 and 13, the sealing element 50 in the shown case has a widened cross-section in those areas that are inserted into the carrier 18. At the free end of the sealing element 50, as shown, for example, at the bottom of FIG. 13, the sealing element 50 has a tapered or rounded cross-section.

The disk 16 shown in FIG. 14 is similar to the one shown in FIG. 4, but in this case all the openings 26 are sector shaped. Furthermore, no radially outward projections 20, as shown in FIG. 4, are provided. Corresponding to the recesses 30 in the webs 28 of the carrier 18, the disk 16 in this case comprises radially extending projections 32, which can be received in the recesses 30. This prevents the two components from rotating relative to one another, and, at the same time, any frictional force that arises between the valve element 14 and the disk 16 can be advantageously introduced into the carrier 18 close to the point of origin and dissipated via the housing. In addition, the recesses 30 and the projections 32 advantageously form a kind of labyrinth seal, which contributes to the overall tightness of the disk 16. The webs 28 are approximately as wide as the circular web between the central opening 24 and the sector-shaped openings 26.

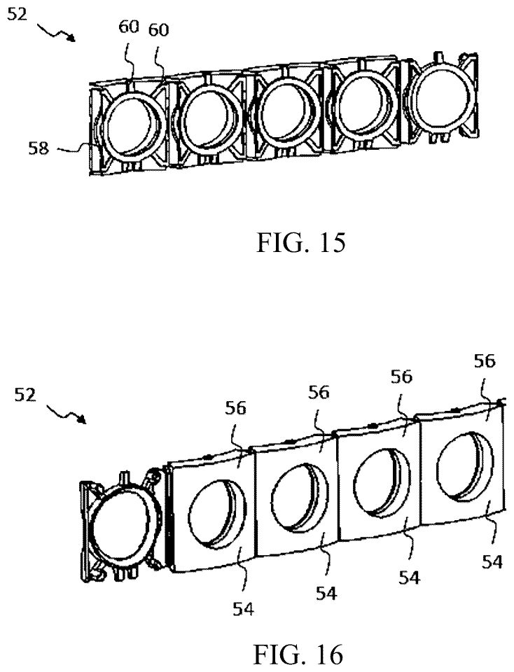

FIGS. 15 and 16 show two perspective views of a radial sealing package 52. In this regard, it should be mentioned that the valve shown in FIG. 1 comprises a valve element 14 that only has axial sealing surfaces. However, as mentioned above, the invention can also be applied to valve elements 14 such as shown in FIGS. 2 and 3 and to valves such as those disclosed in U.S. Pat. No. 11,781,662 B2 or US 2022 381 354 A1 and which contact a sealing package 52, such as shown in FIGS. 15 and 16, in the radial direction. In the installed state, the one end according to FIGS. 15 and 16 is connected to the other end, such that a cylinder with four segments 54 in the installed state is substantially formed.

Since the radial sliding partner in the form of a circular ring 58 and webs 60 extending therefrom corresponds in a radial respect to the axially contacted disk 16, such a sliding partner 58 and 60 comprises, according to the invention, the described particles 46. In other words, a sectional view of the sliding partner 58 and 60 would substantially correspond to that of FIGS. 6 and 7.

In detail, the radial sliding partner 58 and 60 has a substantially cylindrical face 56 on its outer side in the installed state, as can be seen in FIG. 16. It should be noted that the segment on the left in FIG. 16 is connected to the rightmost segment in FIG. 16 in the installed state.

On the inner side that is shown in FIG. 15, the radial sealing surfaces in the form of a circular ring 58 and webs 60 extending therefrom are apparent. For further details, reference is made to US 2022 381 354 A1, which is made subject matter of the present application in this respect.

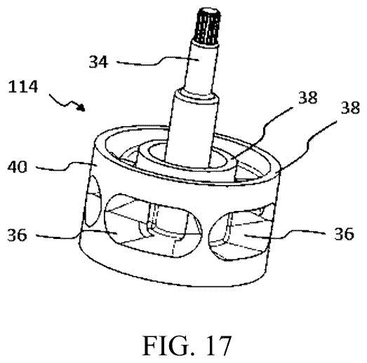

As can be seen in FIG. 17, the valve element 114 that typically interacts with the sealing package 52 described above first of all comprises an axle 34 that is connected to an actuator in order to drive the valve element 14 rotatably about the axle 34. In the shown case, the valve element 14 furthermore consists of two concentric cylinders, the outer one of which comprises substantially oval openings 36. Further openings and chambers are formed between the two cylinders in order to control the desired fluid flow through the valve element 14. The axial sliding surfaces of the valve element 14 are labelled 38, and the radial sliding surfaces are labelled 40. The valve element 14 has the described roughness on at least one of these sliding surfaces 38, 40.

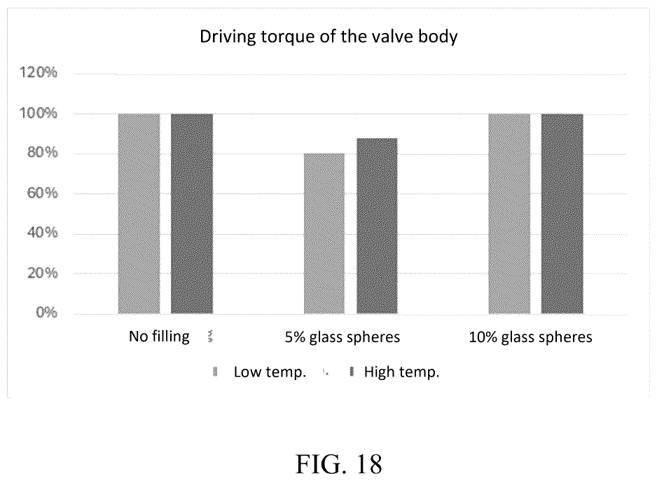

FIG. 18 shows that a proportion of spherical glass particles in the sliding layer of approximately 5% has an advantageous effect on the driving torque of the valve body by reducing friction. Compared to both a sliding layer without such particles and a sliding layer with 10% glass spheres, this driving torque is approximately 20% lower at low temperatures and approximately 15% lower at high temperatures. At the same time, it has been found that wear remains within acceptable limits with a proportion of 5%. Finally, a proportion of 5% spherical particles has a cost advantage over higher proportions.

What is claimed is:

1. A valve for use in a vehicle, the valve comprising:
a rotating valve element that is axially in sliding contact with at least one disk and, also radially in sliding contact with a cylinder, wherein the disk and, the cylinder comprise, in a sliding layer, 3 to 7 vol % of substantially spherical particles.

2. The valve according to claim 1, wherein the disk includes at least in parts of a thermoplastic material of a non-fluorine-based polymer such as POM, PA46, PA9, PE, or PE-UHMW.

3. The valve according to claim 1, wherein the valve element has a roughness Rz of 4 to 10 micrometers, on at least one surface in sliding contact with the disk or the cylinder.

4. The valve according to claim 1, wherein the valve element comprises, on at least one surface in sliding contact with the disk or the cylinder, a structure with channels or grooves that extend substantially transversely to the pressure gradient, with a depth of 8 to 15 micrometers.

5. The valve according to claim 1, wherein the particles have a diameter of 20 to 50 micrometers.

6. The valve according to claim 1, wherein the disk is supported by a carrier that furthermore comprises integrated sealing elements.

7. The valve according to claim 6, wherein the carrier includes at least in parts of a thermoplastic material such as PP, POM, PPS and/or PK, and/or at least one sealing element includes at least in parts of a thermoplastic elastomer such as TPE or TPV, or of a rubber, such as EDPM.

8. The valve according to claim 6, wherein the carrier comprises at least one recess or groove for receiving contaminants and/or a sealing element.

9. The valve according to claim 1, wherein a material of the disk has a melting temperature of 120 to 170 degrees Celsius.

10. The valve according to claim 6, wherein the carrier and/or the disk comprises at least one radially extending projection or a recess that engages with a recess or a projection in the disk and/or the carrier.

11. The valve according to claim 1, wherein the valve element and the disk abut against one another at least in some areas with a surface pressure of 0.05 to 0.1 MPa.

12. A method for producing a valve comprising a rotating valve element that is axially in sliding contact with a disk and, also radially in sliding contact with a cylinder, wherein the disk and, the cylinder are provided, in a sliding layer, with 3 to 7 vol%, of substantially spherical particles.

13. The method according to claim 12, wherein the valve element is provided with a roughness Rz of 4 to 10 micrometers, on at least one surface in sliding contact with the disk or the cylinder.

14. The method according to claim 12, wherein the valve element is provided, on at least one surface in sliding contact with the disk or the cylinder, with a structure comprising channels or grooves that extend substantially transversely to the pressure gradient, with a depth of 8 to 15 micrometers.

15. The method according to claim 13, wherein the roughness is produced during forming of the valve element in a tool by processing the tool by means of laser, erosion, etching and/or blasting.

16. The method according to claim 12, wherein at least one sealing element is moulded onto a carrier supporting the disk.

17. A tool for producing a valve element which, on at least one surface forming a sliding contact surface of the valve element, has a roughness Rz of 4 to 10 micrometers, and/or a structure produced by a laser, milling or erosion comprising channels or grooves having a depth of 8 to 15 micrometers, as a negative mould.

18. The valve according to claim 1, wherein the spherical particles are made of glass or ceramic.

19. The method according to claim 12, wherein the spherical particles are made of glass or ceramic.
